(19) United States
(12) Patent Application Publication
(10) Pub. No.: US 2026/0179289 A1
(43) Pub. Date: Jun. 25, 2026

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventor: Yoshiki MORI, Tokyo (JP)

(73) Assignee: FUJIFILM Corporation, Tokyo (JP)

(21) Appl. No.: 19/414,334

(22) Filed: Dec. 10, 2025

(30) Foreign Application Priority Data
Dec. 19, 2024 (JP) 2024-223823

(51) Int. Cl. G06T 11/00

(52) U.S. Cl. CPC G06T 12/10; G06T 12/20; G06T 2207/10081; G06T 2210/41; G06T 2211/421; G06T 2211/448

(57) ABSTRACT

In a case in which an instruction to start imaging in a CT apparatus is received, an information processing apparatus stores a plurality of first projection data output from the CT apparatus in a storage device in sequence and generates a first CT image by reconstructing an image based on second projection data that is projection data based on the first projection data and that is fewer in number than the first projection data, and the information processing apparatus generates a second CT image by reconstructing the image based on the plurality of first projection data after the imaging in the CT apparatus ends.

### CROSS-REFERENCE TO RELATED APPLICATION

This application claims priority from Japanese Patent Application No. 2024-223823, filed on Dec. 19, 2024, the entire disclosure of which is incorporated herein by reference.

### BACKGROUND

### 1. Technical Field

The present disclosure relates to an information processing apparatus, an information processing method, and an information processing program.

### 2. Description of the Related Art

JP2014-128456A discloses a technology of performing correction processing on projection data output from a computed tomography (CT) apparatus and reconstructing an image based on corrected projection data to generate a CT image.

### SUMMARY

Meanwhile, in a case in which the CT image is generated by storing the projection data, performing the correction processing on the projection data, and performing image reconstruction based on corrected projection data during imaging by the CT apparatus, a processing load may be increased. In this case, due to the influence of the high load, a process of storing the projection data may be delayed or the display of the CT image may be delayed, so that a user may not be able to check whether or not the imaging is normally performed. For example, in a photon-counting CT apparatus, the processing load may be further increased due to an increase in an amount of data of the projection data and an increase in an amount of the correction processing of a radiation detector.

The present disclosure has been made in view of the above-described circumstances, and an object of the present disclosure is to provide an information processing apparatus, an information processing method, and an information processing program that can reduce a processing load during imaging by a CT apparatus.

The technology of the present disclosure relates to an information processing apparatus comprising: a processor configured to: in a case in which an instruction to start imaging in a CT apparatus is received, store a plurality of first projection data output from the CT apparatus in a storage device in sequence and generate a first CT image by reconstructing an image based on second projection data that is projection data based on the first projection data and that is fewer in number than the first projection data; and generate a second CT image by reconstructing the image based on the plurality of first projection data after the imaging in the CT apparatus ends.

The processor may be configured to: after the imaging in the CT apparatus ends, perform correction processing on the plurality of first projection data and store the plurality of first projection data after correction in the storage device; and generate the second CT image by reconstructing the image based on the plurality of first projection data after the correction.

The processor may be configured to: receive reconstruction conditions for the image; and generate a third CT image by reconstructing the image based on the plurality of first projection data after the correction stored in the storage device in accordance with the received reconstruction conditions.

The processor may be configured to: select a reduction parameter for the projection data in accordance with an imaging mode; acquire the second projection data from the first projection data in accordance with the selected reduction parameter; and generate the first CT image by reconstructing the image based on the second projection data.

The processor may be configured to: select a correction parameter in accordance with an imaging mode; perform correction processing on the second projection data in accordance with the selected correction parameter; and generate the first CT image by reconstructing the image based on the second projection data after correction.

The processor may include at least one CPU and at least one GPU.

The CT apparatus may include a photon-counting radiation detector.

The technology of the present disclosure relates to an information processing method executed by a processor provided in an information processing apparatus, the information processing method comprising: in a case in which an instruction to start imaging in a CT apparatus is received, storing a plurality of first projection data output from the CT apparatus in a storage device in sequence and generating a first CT image by reconstructing an image based on second projection data that is projection data based on the first projection data and that is fewer in number than the first projection data; and generating a second CT image by reconstructing the image based on the plurality of first projection data after the imaging in the CT apparatus ends.

The technology of the present disclosure relates to an information processing program causing a processor provided in an information processing apparatus to execute a process comprising: in a case in which an instruction to start imaging in a CT apparatus is received, storing a plurality of first projection data output from the CT apparatus in a storage device in sequence and generating a first CT image by reconstructing an image based on second projection data that is projection data based on the first projection data and that is fewer in number than the first projection data; and generating a second CT image by reconstructing the image based on the plurality of first projection data after the imaging in the CT apparatus ends.

According to the present disclosure, the processing load during imaging by the CT apparatus can be reduced.

### BRIEF DESCRIPTION OF THE DRAWINGS

FIG. 1 is a schematic diagram showing an example of a configuration of a tomographic imaging system.

FIG. 2 is a block diagram showing an example of a hardware configuration of a console.

FIG. 3 is a block diagram showing an example of a functional configuration of the console.

FIG. 4 is a diagram showing a process of generating a first CT image.

FIG. 5 is a diagram showing a process of generating a first CT image according to a modification example.

FIG. 6 is a diagram showing a process of generating the first CT image and a process of storing first projection data.

FIG. 7 is a flowchart showing an example of an imaging control process.

FIG. 8 is a flowchart showing an example of a process of generating a third CT image.

### DETAILED DESCRIPTION

Hereinafter, an embodiment for carrying out the technology of the present disclosure will be described in detail with reference to the drawings.

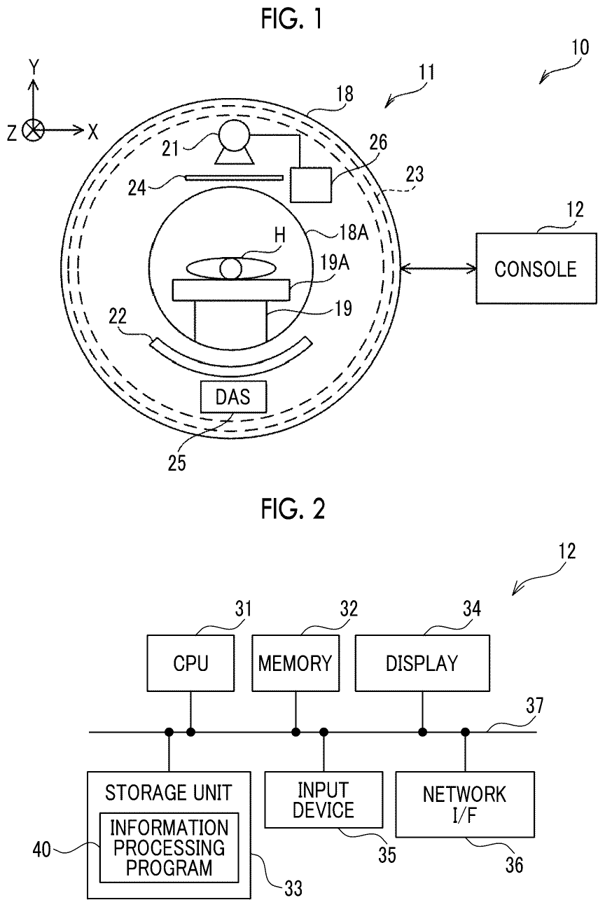

First, a configuration of a tomographic imaging system 10 will be described with reference to FIG. 1. As shown in FIG. 1, the tomographic imaging system 10 according to the present embodiment comprises a CT apparatus 11 and a console 12.

The CT apparatus 11 images a subject H using X-rays, which are an example of radiation, to obtain a CT image including a plurality of tomographic images of the subject H. The CT apparatus 11 comprises a gantry 18 and an examination table device 19. FIG. 1 is a diagram in which a gantry 18 and the examination table device 19 are viewed from the front side. The examination table device 19 comprises a top plate 19A on which the subject H can be placed in a decubitus posture. In the following description, a longitudinal direction of the top plate 19A will be referred to as a Z axis direction, a lateral direction of the top plate 19A will be referred to as an X axis direction, and a vertical direction will be referred to as a Y axis direction. The top plate 19A can move in the Z axis direction in a state of being kept horizontal. The gantry 18 has an annular shape as a whole, and a circular opening portion 18A having a diameter larger than a width of the top plate 19A is formed at the center thereof. During the imaging, the top plate 19A on which the subject H is placed is moved in the Z axis direction with respect to the gantry 18, to enter the opening portion 18A. The imaging is performed while moving the top plate 19A with respect to the gantry 18.

A radiation source 21, a radiation detector 22, and a frame 23 are disposed inside the gantry 18. The radiation source 21 emits the radiation toward the subject H. The radiation detector 22 detects the radiation transmitted through the subject H. The radiation transmitted through the subject His attenuated by interaction (for example, absorption and scattering of the radiation) with structures such as organs and bones inside the body of the subject H. The structures each have an attenuation coefficient for the radiation peculiar to the structures, and the radiation transmitted through the structures carries information reflecting the physical properties of the structures. The radiation detector 22 detects the radiation in which physical properties of the structure in the body of the subject H are reflected. The radiation detector 22 has a detection surface in which detection elements are two-dimensionally arranged, and outputs a detection signal for each of the detection elements. For this reason, the radiation detector 22 can detect the radiation at each transmission position transmitted through the structure of the subject H. In addition, the radiation detector 22 has a substantially arc shape in accordance with a curvature of the gantry 18, and the detection surface is also curved. The radiation detector 22 is an example of a photon-counting radiation detector, and is a radiation detector that can count the number of photons of incident radiation. That is, the CT apparatus 11 is a photon-counting computed tomography (PCCT) apparatus. The radiation detector 22 may be, for example, an energy-integrating type radiation detector that converts radiation into visible light and then accumulates charges, which are generated by converting the visible light into an electric signal, for a certain time.

The radiation source 21 and the radiation detector 22 are disposed at positions facing each other in the gantry 18 and are rotated around the Z axis while remaining facing each other. The frame 23 has an annular shape and supports the radiation source 21 and the radiation detector 22 in a rotatable manner. During the imaging, the gantry 18 acquires the detection signals by the radiation detector 22 at a plurality of positions in a circumferential direction around the Z axis corresponding to the body axis of the subject H while rotating the radiation source 21 and the radiation detector 22 around the subject H on the top plate 19A. During the imaging, the top plate 19A also moves in the Z axis direction in synchronization with the rotation of the radiation source 21 and the radiation detector 22.

A data acquisition system (DAS) 25 collects the detection signal output by the radiation detector 22, generates output data at each position around the Z axis based on the collected detection signal, and outputs the generated output data to the console 12. In a case in which the subject His present between the radiation source 21 and the radiation detector 22, this output data is projection data in which the subject H is projected.

An irradiation field limiter 24 (also referred to as a collimator) that limits an irradiation field of the radiation is disposed in front of the radiation source 21 in an irradiation direction. The irradiation field limiter 24 has an irradiation opening of which a contour is defined by a plurality of shielding plates for shielding the radiation, and a size of the irradiation opening can be changed by moving the shielding plates. A voltage is supplied to the radiation source 21 from a high-voltage generator 26. The radiation source 21 and the radiation detector 22 are electrically connected to the frame 23 by a slip ring method, and, for example, power supply, transmission and reception of data, and the like are performed via a slip ring. The connection using the slip ring method allows the radiation source 21 and the radiation detector 22 to perform imaging of a helical scan method in which imaging is performed while rotating in one direction without reversing the rotation direction.

The console 12 controls the radiation source 21 and the radiation detector 22 via a control device (not shown) provided in the gantry 18. The console 12 is an example of an information processing apparatus according to the disclosed technology. The imaging conditions of the CT apparatus 11 are set by the operation from the console 12. The imaging conditions include an irradiation condition of the radiation of the radiation source 21, an imaging range, and the like. The irradiation condition of the radiation includes a tube voltage (unit: kV) to be applied to the radiation source 21, a tube current (unit: mA), and an irradiation time (unit: msec) of the radiation. The imaging range is adjusted, for example, by changing the size of the irradiation opening of the irradiation field limiter 24 in the X-Y plane, and is adjusted by changing a movement range of the top plate 19A in the Z axis direction.

A hardware configuration of the console 12 according to the present embodiment will be described with reference to FIG. 2. Examples of the console 12 include a computer, such as a personal computer or a server computer. As shown in FIG. 2, the console 12 includes a central processing unit (CPU) 31, a memory 32 as a temporary storage area, and a non-volatile storage unit 33. Further, the console 12 includes a display 34 such as a liquid crystal display, an input device 35 such as a keyboard and a mouse, and a network interface (I/F) 36 connected to the CT apparatus 11. The CPU 31, the memory 32, the storage unit 33, the display 34, the input device 35, and the network I/F 36 are connected to a bus 37. The CPU 31 is an example of a processor according to the technology of the present disclosure.

The storage unit 33 is implemented by using a hard disk drive (HDD), a solid state drive (SSD), a flash memory, and the like. An information processing program 40 is stored in the storage unit 33 as a storage medium. The CPU 31 reads out the information processing program 40 from the storage unit 33, loads the read out information processing program 40 into the memory 32, and executes the loaded information processing program 40.

In the CT apparatus 11, in a case of capturing the CT image, the projection data is stored, the correction processing is performed on the projection data, and the image is reconstructed based on the corrected projection data. The projection data is stored in order to reconstruct the image under reconstruction conditions different from conditions used during the imaging. The image reconstruction during the imaging is performed by the user such as a technician to check whether or not the imaging is correctly performed. The correction processing on the projection data is performed for the image reconstruction.

In a case in which the load of the console 12 is increased by the process performed during the imaging by the CT apparatus 11, a process of storing the projection data may be delayed or the display of the CT image may be delayed, so that the user may not be able to check whether or not the imaging is normally performed. In a case in which the irradiation of the radiation ends without checking that the projection data is normally stored in a case in which the process of storing the projection data is delayed, there is a possibility that the projection data cannot be normally stored. On the other hand, in a case in which the irradiation of the radiation ends after checking that the projection data is normally stored in a case in which the process of storing the projection data is delayed, an irradiation dose of the radiation to the subject His increased. In a case in which the process of storing the projection data is delayed, there is a possibility that the projection data is not stored even though the subject His irradiated with the radiation. Therefore, the console 12 according to the present embodiment has a function of simply reconstructing the image to reduce the load of the process performed during the imaging by the CT apparatus 11.

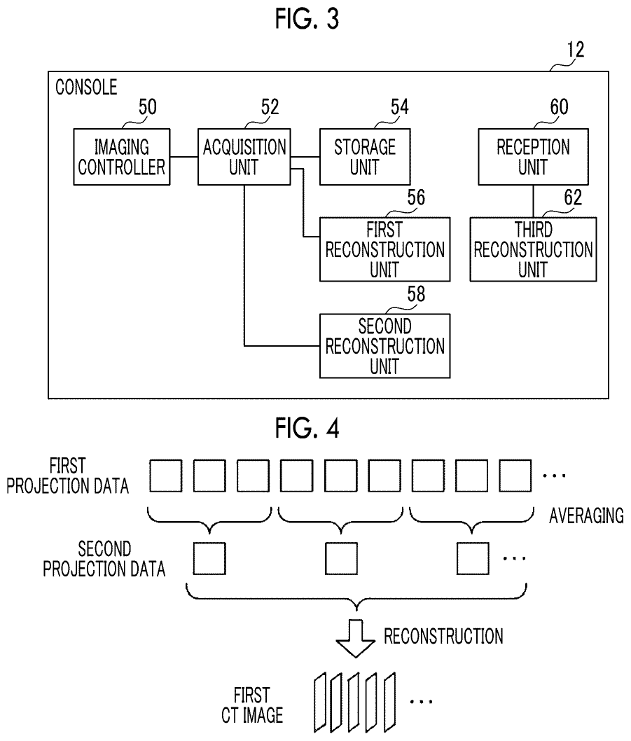

Next, a functional configuration of the console 12 will be described with reference to FIG. 3. As shown in FIG. 3, the console 12 includes an imaging controller 50, an acquisition unit 52, a storage unit 54, a first reconstruction unit 56, a second reconstruction unit 58, a reception unit 60, and a third reconstruction unit 62. The CPU 31 executes the information processing program 40 to function as the imaging controller 50, the acquisition unit 52, the storage unit 54, the first reconstruction unit 56, the second reconstruction unit 58, the reception unit 60, and the third reconstruction unit 62.

In a case in which an instruction to start the imaging in the CT apparatus 11 is received, the imaging controller 50 starts the irradiation of the radiation and performs control of capturing the CT image of the subject H by the helical scan method in accordance with the imaging conditions. The instruction to start the imaging is, for example, input by the user via the input device 35.

The acquisition unit 52 sequentially acquires a plurality of first projection data output from the DAS 25 under the control of the imaging controller 50. The storage unit 54 stores the plurality of first projection data acquired by the acquisition unit 52 in the storage unit 33 in sequence. The storage unit 33 is an example of a storage device according to the disclosed technology. In the present embodiment, the storage unit 54 stores the first projection data in the storage unit 33 each time the first projection data is acquired from the DAS 25. That is, during the imaging by the CT apparatus 11, the first projection data is stored in the storage unit 33 in real time.

The first reconstruction unit 56 generates the first CT image by reconstructing the image based on second projection data that is the projection data based on the first projection data and that is fewer in number than the first projection data. Hereinafter, an example of the process of reconstructing the image by the first reconstruction unit 56 will be described.

The first reconstruction unit 56 acquires the second projection data fewer in number than the first projection data based on the first projection data. As shown in FIG. 4 as an example, the first reconstruction unit 56 acquires one second projection data by averaging two or more (three in the example of FIG. 4) first projection data items set in advance. The first reconstruction unit 56 averages the first projection data each time the acquisition unit 52 acquires a preset number of first projection data items. As a result, the second projection data is fewer in number than the first projection data. In the present embodiment, the first reconstruction unit 56 acquires the second projection data fewer in number than the first projection data in each of a channel direction and a body axis direction of the subject H.

The first reconstruction unit 56 performs the correction processing on the acquired second projection data. Examples of the correction processing include logarithmic conversion processing, offset correction, sensitivity correction, and beam hardening correction. The first reconstruction unit 56 generates the first CT image by reconstructing the image based on the corrected second projection data. The image is reconstructed by, for example, a filtered back projection method. The first reconstruction unit 56 reconstructs the image each time the number of second projection data items reaches the number that allows generation of the tomographic image. As a result, the first CT image is displayed on the display 34 during the imaging, so that the user can check whether or not the imaging is normally performed.

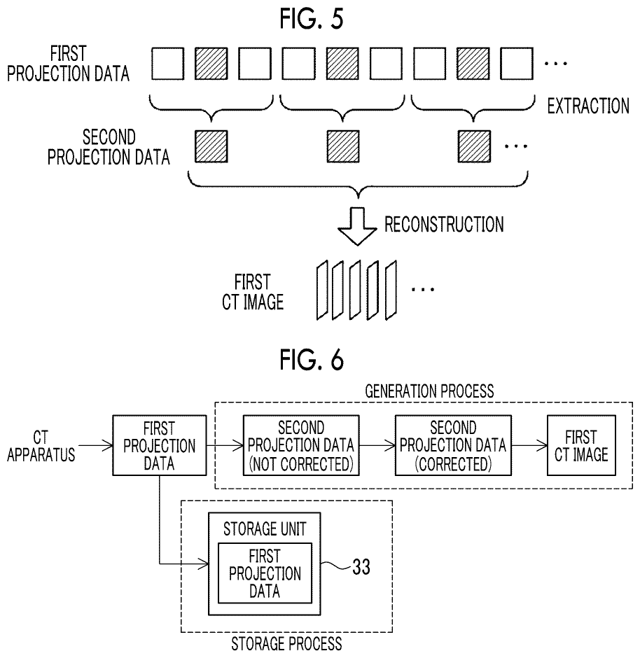

As shown in FIG. 5 as an example, the first reconstruction unit 56 may acquire one second projection data by extracting one projection data from two or more first projection data items set in advance. FIG. 5 shows an example in which the projection data shaded with diagonal lines is extracted.

As shown in FIG. 6 as an example, the process of generating the first CT image using the first projection data output from the CT apparatus 11 and the process of storing the first projection data in the storage unit 33 may be executed in parallel. A plurality of cores provided in the CPU 31 may share the parallel processes. In addition, the console 12 may include at least one CPU and at least one graphics processing unit (GPU), and the CPU and the GPU may share the parallel processes. In a case in which the CPU and the GPU share the parallel processes, for example, the GPU may be responsible for the process of generating the first CT image using the first projection data, and the CPU may be responsible for the process of storing the first projection data in the storage unit 33.

The second reconstruction unit 58 generates the second CT image by reconstructing the image based on the plurality of first projection data after the imaging in the CT apparatus 11 ends. Specifically, after the imaging in the CT apparatus 11 ends, the second reconstruction unit 58 performs the correction processing on the plurality of first projection data and stores the plurality of corrected first projection data in the storage unit 33. Further, the second reconstruction unit 58 generates the second CT image by reconstructing the image based on the plurality of corrected first projection data. The second CT image is used for, for example, image interpretation. Examples of the correction processing include logarithmic conversion processing, offset correction, sensitivity correction, and beam hardening correction. In addition, the image is reconstructed by, for example, a filtered back projection method.

The reception unit 60 receives the reconstruction conditions for the image. The user may want to reconstruct the image under the reconstruction conditions different from conditions during the imaging. For example, a metal artifact reduction (correction) function is on to reconstruct the image since a metal object is shown in the second CT image. Examples of the reconstruction conditions include whether the metal artifact reduction function is on or off, whether a motion correction function is on or off, filter setting depending on an imaging target part, and field of view (FOV) setting. In this case, for example, the user inputs the reconstruction conditions for the image via the input device 35.

The third reconstruction unit 62 generates a third CT image by reconstructing the image based on the plurality of corrected first projection data stored in the storage unit 33 in accordance with the reconstruction conditions received by the reception unit 60. The image is reconstructed by, for example, a filtered back projection method. As described above, in a case in which the third CT image is generated under the reconstruction conditions different from those of the second CT image, the plurality of corrected first projection data stored in a case of generating the second CT image is used. As a result, it is possible to shorten a time required for the process of generating the third CT image as compared with a case in which the correction processing is performed on the plurality of first projection data in a case of generating the third CT image.

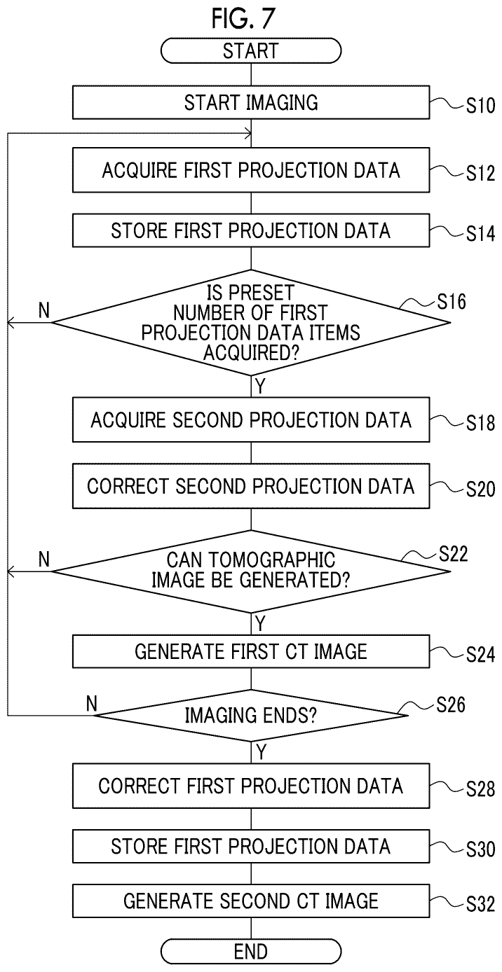

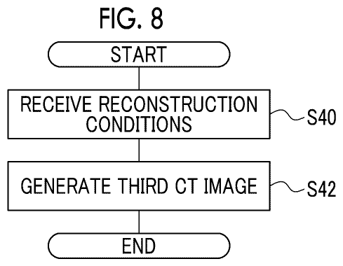

Next, an operation of the console 12 will be described with reference to FIGS. 7 and 8. The CPU 31 executes the information processing program 40 to execute an imaging control process shown in FIG. 7 and a process of generating the third CT image shown in FIG. 8. The imaging control process is executed, for example, in a case in which the instruction to start the imaging is input by the user. The process of generating the third CT image is executed, for example, in a case in which the reconstruction conditions for the image are input by the user.

In step S10 of FIG. 7, the imaging controller 50 starts the irradiation of the radiation and performs control of capturing the CT image of the subject H by the helical scan method in accordance with the imaging conditions. In step S12, the acquisition unit 52 acquires the first projection data output from the DAS 25. In step S14, the storage unit 54 stores the first projection data acquired in step S12 in the storage unit 33. By repeating the processes of step S12 and step S14, the plurality of first projection data are sequentially acquired and stored in the storage unit 33.

In step S16, the first reconstruction unit 56 determines whether or not the preset number of first projection data items is acquired by the process of step S12. In a case in which the determination result is No, the process returns to step S12, and in a case in which the determination result is Yes, the process proceeds to step S18.

In step S18, the first reconstruction unit 56 acquires one second projection data by averaging the preset number of first projection data items acquired in step S12. In step S20, the first reconstruction unit 56 corrects the second projection data acquired in step S18. In step S22, it is determined whether or not the number of corrected second projection data items obtained by the process of step S20 reaches the number that allows the generation of the tomographic image. In a case in which the determination result is No, the process returns to step S12, and in a case in which the determination result is Yes, the process proceeds to step S24.

In step S24, the first reconstruction unit 56 generates the first CT image by reconstructing the image based on the corrected second projection data. The first CT image is displayed on the display 34. Each time the process of step S24 is executed, the first CT image to which the tomographic image is added is generated.

In step S26, the imaging controller 50 determines whether or not the imaging ends. In a case in which the determination result is No, the process returns to step S12, and in a case in which the determination result is Yes, the process proceeds to step S28. In step S28, the second reconstruction unit 58 performs the correction processing on the plurality of first projection data acquired by repeating the process of step S12. In step S30, the second reconstruction unit 58 stores the plurality of corrected first projection data obtained by the process of step S28 in the storage unit 33.

In step S32, the second reconstruction unit 58 generates the second CT image by reconstructing the image based on the plurality of corrected first projection data obtained by the process of step S28. In a case in which the process of step S32 ends, the imaging control process ends.

In step S40 of FIG. 8, the reception unit 60 receives the reconstruction conditions for the image. In step S42, the third reconstruction unit 62 generates the third CT image by reconstructing the image based on the plurality of corrected first projection data stored in the storage unit 33 in accordance with the reconstruction conditions received in step S40. In a case in which the process of step S42 ends, the process of generating the third CT image ends.

As described above, according to the present embodiment, the correction processing that is relatively high in load and is performed during the imaging is performed on the second projection data fewer in number than the first projection data. Therefore, the load of the process performed during the imaging by the CT apparatus can be reduced. As a result, it is possible to store the projection data during the imaging and to check the imaging status by the CT image.

In the above-described embodiment, the first reconstruction unit 56 may select a reduction parameter for the projection data in accordance with the imaging mode (for example, a reduction parameter for the number or volume of data items), and acquire the second projection data from the first projection data in accordance with the selected reduction parameter. In this case, the first reconstruction unit 56 generates the first CT image by reconstructing the image based on the second projection data acquired in accordance with the reduction parameter. Examples of the reduction parameter include a ratio of the number of second projection data items to the number of first projection data items in the channel direction and a ratio of the number of second projection data items to the number of first projection data items in the body axis direction. Examples of the imaging mode include a high-definition mode, a material discrimination mode, and a hybrid mode of the high-definition mode and the material discrimination mode. In this embodiment, a set of a plurality of reduction parameters in accordance with the imaging mode may be stored in the storage unit 33. In addition, the first reconstruction unit 56 may reduce the number of second projection data items as the image quality of the first CT image required by the imaging mode becomes lower.

In addition, in the above-described embodiment, the first reconstruction unit 56 may select a correction parameter in accordance with the imaging mode, and perform the correction processing on the second projection data in accordance with the selected correction parameter. In this case, the first reconstruction unit 56 generates the first CT image by reconstructing the image based on the corrected second projection data in accordance with the selected correction parameter. Examples of the correction parameter include a parameter for the logarithmic conversion processing, the offset correction, the sensitivity correction, and the beam hardening correction. Examples of the imaging mode include a high-definition mode, a material discrimination mode, and a hybrid mode of the high-definition mode and the material discrimination mode. In this embodiment, a set of a plurality of correction parameters in accordance with the imaging mode may be stored in the storage unit 33.

In addition, at least one of the functional units provided in the console 12 in the above-described embodiment may be provided in another device such as the control device provided in the gantry 18.

In addition, in the above-described embodiment, each process is executed by any computer. Any computer may execute these processes by a processor as hardware, a program as software, or a combination thereof. In such a case, the processor is configured to execute various processes in the above-described embodiment in cooperation with the program, and may function as each unit or each means in the above-described embodiment. In addition, the execution order of the processes by the processor is not limited to the above order, and may be changed as appropriate. Any computer may be a general-purpose computer, a dedicated computer, a workstation, or another system that can execute each process.

The processor may be configured by one or more kinds of hardware, and the type of hardware is not limited. For example, the processor may be configured by a programmable logic device such as a central processing unit (CPU), a microprocessing unit (MPU), or a field programmable gate array (FPGA), a dedicated circuit for executing specific processing, such as an application-specific integrated circuit (ASIC), or hardware such as a graphics processing unit (GPU) or a neural processing unit (NPU). Moreover, the type of hardware may be a combination of different kinds of hardware. In a case in which the plurality of types of hardware are configured to execute one or a plurality of processes of a certain processor, the plurality of types of hardware may be present in devices physically separated from each other or may be present in the same device. Furthermore, in any of the embodiments, the order of each process performed by the processor is not limited to the above-described order, and may be changed as appropriate. In addition, hardware is implemented in a form of an electrical circuit (circuitry) in which circuit elements, such as semiconductor elements, are combined.

Furthermore, the program may be software such as firmware or microcode. The program may be, for example, a group of program modules, and each function thereof may be implemented by a processor configured to execute each function. The program may be a program code or a plurality of code segments stored in one or more non-transitory computer-readable media (for example, a storage medium and other storages). The program may be stored in the plurality of non-transitory computer-readable media present in devices physically separated from each other. The program code or the code segment may represent any combination of procedures, functions, subprograms, routines, subroutines, modules, software packages, classes, instructions, data structures, or program statements. The program code or the code segment may be connected to another code segment or a hardware circuit by transmitting and receiving information, data, arguments, parameters, or contents in the memory.

In addition, in the above-described embodiment, the aspect has been described in which the information processing program 40 is stored (installed) in the storage unit 33 in advance, but the present disclosure is not limited to this. The information processing program 40 may be provided in a form of being recorded in the recording medium such as a compact disc read only memory (CD-ROM), a digital versatile disc read only memory (DVD-ROM), and a universal serial bus (USB) memory. In addition, the information processing program 40 may be provided in a form being downloaded from an external device via a network. Further, the information processing program 40 can be provided as a program product. The program product includes products in any aspect for providing the program. For example, the program product includes a program provided through a network such as the Internet, and non-transitory computer-readable recording media such as a CD-ROM and a DVD in which the program is stored.

In regard to the above-described embodiment, the following supplementary notes are further disclosed.

### Supplementary Note 1

An information processing apparatus comprising: a processor configured to: in a case in which an instruction to start imaging in a CT apparatus is received, store a plurality of first projection data output from the CT apparatus in a storage device in sequence and generate a first CT image by reconstructing an image based on second projection data that is projection data based on the first projection data and that is fewer in number than the first projection data; and generate a second CT image by reconstructing the image based on the plurality of first projection data after the imaging in the CT apparatus ends.

### Supplementary Note 2

The information processing apparatus according to supplementary note 1, in which the processor is configured to: after the imaging in the CT apparatus ends, perform correction processing on the plurality of first projection data and store the plurality of first projection data after correction in the storage device; and generate the second CT image by reconstructing the image based on the plurality of first projection data after the correction.

### Supplementary Note 3

The information processing apparatus according to supplementary note 2, in which the processor is configured to: receive reconstruction conditions for the image; and generate a third CT image by reconstructing the image based on the plurality of first projection data after the correction stored in the storage device in accordance with the received reconstruction conditions.

### Supplementary Note 4

The information processing apparatus according to any one of supplementary notes 1 to 3, in which the processor is configured to: select a reduction parameter for the projection data in accordance with an imaging mode; acquire the second projection data from the first projection data in accordance with the selected reduction parameter; and generate the first CT image by reconstructing the image based on the second projection data.

### Supplementary Note 5

The information processing apparatus according to any one of supplementary notes 1 to 4, in which the processor is configured to: select a correction parameter in accordance with an imaging mode; perform correction processing on the second projection data in accordance with the selected correction parameter; and generate the first CT image by reconstructing the image based on the second projection data after correction.

### Supplementary Note 6

The information processing apparatus according to any one of supplementary notes 1 to 5, in which the processor includes at least one CPU and at least one GPU.

### Supplementary Note 7

The information processing apparatus according to any one of supplementary notes 1 to 6, in which the CT apparatus includes a photon-counting radiation detector.

### Supplementary Note 8

An information processing method executed by a processor provided in an information processing apparatus, the information processing method comprising: in a case in which an instruction to start imaging in a CT apparatus is received, storing a plurality of first projection data output from the CT apparatus in a storage device in sequence and generating a first CT image by reconstructing an image based on second projection data that is projection data based on the first projection data and that is fewer in number than the first projection data; and generating a second CT image by reconstructing the image based on the plurality of first projection data after the imaging in the CT apparatus ends.

### Supplementary Note 9

An information processing program causing a processor provided in an information processing apparatus to execute a process comprising: in a case in which an instruction to start imaging in a CT apparatus is received, storing a plurality of first projection data output from the CT apparatus in a storage device in sequence and generating a first CT image by reconstructing an image based on second projection data that is projection data based on the first projection data and that is fewer in number than the first projection data; and generating a second CT image by reconstructing the image based on the plurality of first projection data after the imaging in the CT apparatus ends.

What is claimed is:

1. An information processing apparatus comprising:
a processor configured to:
in a case in which an instruction to start imaging in a CT apparatus is received, store a plurality of first projection data output from the CT apparatus in a storage device in sequence and generate a first CT image by reconstructing an image based on second projection data that is projection data based on the first projection data and that is fewer in number than the first projection data; and
generate a second CT image by reconstructing the image based on the plurality of first projection data after the imaging in the CT apparatus ends.

2. The information processing apparatus according to claim 1,
wherein the processor is configured to:
after the imaging in the CT apparatus ends, perform correction processing on the plurality of first projection data and store the plurality of first projection data after correction in the storage device; and
generate the second CT image by reconstructing the image based on the plurality of first projection data after the correction.

3. The information processing apparatus according to claim 2,
wherein the processor is configured to:
receive reconstruction conditions for the image; and
generate a third CT image by reconstructing the image based on the plurality of first projection data after the correction stored in the storage device in accordance with the received reconstruction conditions.

4. The information processing apparatus according to claim 1,
wherein the processor is configured to:
select a reduction parameter for the projection data in accordance with an imaging mode;
acquire the second projection data from the first projection data in accordance with the selected reduction parameter; and
generate the first CT image by reconstructing the image based on the second projection data.

5. The information processing apparatus according to claim 1,
wherein the processor is configured to:
select a correction parameter in accordance with an imaging mode;
perform correction processing on the second projection data in accordance with the selected correction parameter; and
generate the first CT image by reconstructing the image based on the second projection data after correction.

6. The information processing apparatus according to claim 1,
wherein the processor includes at least one CPU and at least one GPU.

7. The information processing apparatus according to claim 1,
wherein the CT apparatus includes a photon-counting radiation detector.

8. An information processing method executed by a processor provided in an information processing apparatus, the information processing method comprising:
in a case in which an instruction to start imaging in a CT apparatus is received, storing a plurality of first projection data output from the CT apparatus in a storage device in sequence and generating a first CT image by reconstructing an image based on second projection data that is projection data based on the first projection data and that is fewer in number than the first projection data; and
generating a second CT image by reconstructing the image based on the plurality of first projection data after the imaging in the CT apparatus ends.

9. A non-transitory computer-readable storage medium storing an information processing program causing a processor provided in an information processing apparatus to execute a process comprising:
in a case in which an instruction to start imaging in a CT apparatus is received, storing a plurality of first projection data output from the CT apparatus in a storage device in sequence and generating a first CT image by reconstructing an image based on second projection data that is projection data based on the first projection data and that is fewer in number than the first projection data; and
generating a second CT image by reconstructing the image based on the plurality of first projection data after the imaging in the CT apparatus ends.
